(19) United States
(12) Patent Application Publication
(10) Pub. No.: US 2016/0269345 A1
(43) Pub. Date: Sep. 15, 2016

(54) Systems and Method for Reducing Biases and Clutter When Ranking User Content and Ideas

(71) Applicant: Mordechai Weizman, Oak Park, CA (US)

(72) Inventor: Mordechai Weizman, Oak Park, CA (US)

(21) Appl. No.: 15/058,347

(22) Filed: Mar. 2, 2016

Related U.S. Application Data
(60) Provisional application No. 62/126,737, filed on Mar. 2, 2015.

(51) Int. Cl. H04L 12/58

(52) U.S. Cl. CPC H04L 51/32; H04L 51/36; H04L 51/12

(57) ABSTRACT

A method, implemented on a processor, for reducing user biases and exposure to clutter when ranking user content is disclosed. In this method, users are selected from at least one online grouping of users, such as an interest group or social group. A small subset of users is calculated, which may be from one or more groups. Content is anonymously submitted to the subset of users and they can review and anonymously respond to the content. The weight of the content is increased by positive response and decreased by negative responses. This process is repeated for a predetermined period of time, number of iterations or until a predetermined end point. A numerical value of the content rating is assigned based on the user responses and compared to a calculated numerical threshold. Only content that exceeds the numerical threshold is made available to all users of the online grouping of users.

### RELATED APPLICATIONS

This application claims priority to U.S. Provisional Application No. 62/126,737 filed Mar. 2, 2015. The entire contents of the above application are hereby incorporated by reference as though fully set forth herein.

### FIELD

The present invention relates to the field of data processing. More specifically, the present invention relates to data processing based on record popularity and relevance.

### BACKGROUND

Current quality measures in user networks and online communities are subject to many biases with respect to determining content or user quality/weight. Another known problem with current content ranking methods is the inability to scale ranking to a large number of content items without increasing the clutter. Also, current networks are not specifically geared towards evolving a piece of content into high quality/weight content with the help of users.

In current online forums, social media networks and subscriber networks new, content is made available to a fixed group of users/consumers such that the users of the group may respond to the content in various ways, such as clicking an “upvote” button. The responses are then analyzed and the content weight/rank is extrapolated from the plurality of responses. Normally in such communities (a) the identity of the user that initiated the content is made public immediately and/or (b) the target group of users that the content is made available to is fixed and predefined (can be a group with shared interest or social connections, etc.) and/or (c) the past responses of users to the content is visible, to all subsequent users, immediately or after some delay. This method is subject to several types of biases, such as (a) the celebrity bias wherein the social status of the content's publisher significantly affects other users' responses; (b) past responses bias wherein existing positive responses are more likely to generate more positive responses; (c) manipulation bias wherein responses can be manipulated by interest groups, for example, the publisher may ask friends or hire people to respond positively, which then sets in motion the past responses bias described in b above; (d) the random bias wherein good content that, by luck, did not get immediate attention after posting gets buried in the stream of new posts and will never rise above the background noise level of posts; (e) the noise bias wherein very few users have the time to respond to a large amount of new contents that is made available to everybody, thus normally, initial responses to content, which is critical, is influenced by a small group of people that dedicate a lot of their time responding to new content.

It is therefore an object of the present invention to significantly reduce, if not eliminate, the biases described above in responses to and ranking of content in user networks and online communities. Another object of the present invention is minimize bias while minimizing the amount of raw un-vetted content each user is exposed to, to attract more quality busy people to discover and make a difference at fraction of the time, compared to current online forums and social networks.

### BRIEF SUMMARY OF THE INVENTION

In one embodiment of the present invention, a method, implemented on a processor, for reducing user biases and exposure to clutter when ranking user content is disclosed. In this method, users are selected from at least one online grouping of users, such as an interest group or social group. A small subset of users is calculated, which may be from one or more groups. Content is anonymously submitted to the subset of users and they can review and anonymously respond to the content. Essentially a statistical poll is done on every piece of submitted content wherein the weight of the content is increased by positive response and decreased by negative responses. This process is repeated for a predetermined period of time, number of iterations or until a predetermined end point. A numerical value of the content rating is assigned based on the user responses and compared to a calculated numerical threshold. Only content that exceeds the numerical threshold is made available to all users of the online grouping of users.

In a further embodiment of the present invention, a non-transient computer-readable medium storing instructions, which when executed by a processor cause the processor to perform the method for reducing user biases and exposure to clutter when ranking user content disclosed above.

In a further embodiment of the present invention, a computer-implemented system for reducing user biases and exposure to clutter when ranking user content is disclosed, the system generally comprising (1) a machine; (2) a processor; (3) a memory coupled to the processor; and (4) software or hardware which when executed by a the processor cause the processor to perform the method for reducing user biases and exposure to clutter when ranking user content disclosed above.

In some embodiments, the user content to be ranked may be received from a data feed; however, user content may be received in any suitable data format. For example, in some embodiments, the data feed is selected from the group comprising a really simple syndication (RSS) feed, an atom feed, an extensible markup language (XML) feed, or a JavaScript Object Notation (JSON) format.

In some embodiments, the user content source is initiated by the group comprising a social media network, a social messaging service, a social content sharing service (such as Instagram), an e-mail message service, an instant message service, a short message service (SMS) message, a web service, a weblog, a search engine or combinations thereof.

### BRIEF DESCRIPTION OF THE DRAWINGS

FIG. 1. Is a graphical representation of the present invention.

FIG. 2. Is a screen shot wherein a website is the user interface is shown.

### DETAILED DESCRIPTION

This disclosure is directed to a system and process on social networks and/or online communities to provide an unbiased (a) ranking of quality or importance of content or ideas or users with minimal amount of effort to contributors and rankers or (b) evolution of content or ideas of any kind. The main differences from existing system are (a) during the voting period, the content publisher is anonymous to eliminate celebrity bias and (b) during the voting period the post is available only to users randomly or uniquely selected smaller sub-group from an interest/social groups for rating/responding to the user content in order to spread and share the response load to all contents between all the users in the interest group, which eliminates both the random and noise bias. (c) The smaller sub-group is selected randomly, which mean the content originator does not have any control over who will respond to the content so that the weight/ranking is more likely to follow the wisdom of the crowd and provide a statistically more accurate ranking, thereby eliminating the manipulation bias. (d) Additionally, the user responses to content may be anonymous to eliminate social pressure, (e) responses are also not publicly available during the voting period to eliminate the past response bias. (f) After the voting period is complete, the identity of the publisher and the responders may or may not be made public and additional responses may or may not be possible. In this system, users may subscribe to or select an interest group or groups. An interest may include, but is not limited to, a specific physical location, personal or professional interest, or age group, etc. When a user submits content he can target one or more interest groups, or an intersection of interest groups (i.e. users from specific location with specific interest). User submitted content can be anything a user wants (e.g. article, image, link, idea, suggestion, design, opinion, poll, survey, question, request to participate in some activity, request to join a community on other services such as twitter, chat etc.). A content submission may include types of action/s requested from the users receiving the content. Examples of possible action/s include but are not limited to: (a) fill comment or answer; (b) edit original content; (c) select between such as, stop (not interesting content) or interesting (forward content to community); (d) subscribe to a new community on such as twitter or facebook; (e) “Sign-Me up to receive all activity resulting from this submission”; or (f) numerical ranking, that may be achieved, for example by simple up/down/skip votes (g) Reply to the content, such that the reply is submitted as a new content that is up for the same ranking process as any other new content.

The system may assign a numerical weight to each user submitted content in an online community with the purpose of “measuring” its relative importance/quality/interest. The weight of each piece of content will be determined during the voting phase. After content submission the system will calculate a small, random subset of users in the submitter's target-group/s (“assigned users”) and ask them to review and respond to the posted content. Depending on the action type/s the submitter attached to the content, each user that receives the content may choose to approve it or request to stop forwarding the content (down vote). If the content is approved, it increases its weight by some calculated value. As a function of the individual or combined users response to the content, the system may then calculate another small, random subset of users subscribed to the target group/s and let them view and respond to the posted/edited content. This process will continue until it reaches a dead-end, in which the calculated next small random subset of users is zero. This process may also be terminated when reaching a threshold such as maximum users assigned for response or time limit for responses. Once this process ends, the system will calculate the content voting phase rating as a function of various parameters, and if the rating has crossed a threshold, it may be made available to all users in the interest group. By this method, high quality user submissions may spread and become popular and available throughout the group without having each member being bombarded with all new submissions, so most users will deal with very few low grade content and more higher grade content. This is the equivalent of running a statistical poll on every piece of new content before deciding to publish it to everybody. Further more, by replying and submitting the reply as new content, it may evolve into much higher quality content. Optionally, the content and its rating results could be private and made available to the submitter only.

This same process may also be employed to form new interest groups, for example, by sending a piece of content with a request to form a new group, which users can then approve to create/join the requested group. If there is a statistical interest in such a group, the request will reach more people and the group will grow. Otherwise, the stream of requests will reach a dead end quickly. The system may provide means for members of the newly formed group to communicate with each other.

This process eliminates celebrity bias since it is based on anonymous submissions. It eliminates past ranking influence since it does not provide past ranking along with submitted content. It eliminates manipulation by interest since only a small random groups of users has the power to decide whether or not to keep a specific content alive by approving it. It also scales the power to eliminate a large amount of content by having a small random group eliminate it almost immediately

The uses of the outcome of this process, such as content numerical weight, are beyond the scope of this description. It can be used to create a set of high quality content, to create groups, evolve content, to perform marketing research, to run an organization, and for many other purposes.

Users may elect to limit the amount of submissions they receive. The system may limit the amount of assigned/published submissions per user; this limit may or may not be a function of the quality of past content submitted by the user as the determined by the system.

The user interface for users to interact with the processes can be as simple as email exchanges, or orchestrated by a full, custom implementation of a web or mobile application with means for content publishers to define the content, group/s and actions, and send it, and for the content consumers to forward/abort/edit the content.

New content may be fed by users but can also be automatically fed in from any source, such as an RSS feed, Google alert feed, feeds back user respond to a question back as new content to rate answer popularity, or any other source of raw content for which an interest group may find value in ranking or filtering out the highest quality content.

The system may calculate a new sub interest groups and suggest users to join along with other similar interest of users.

The system may provide services such as crowd content curation to, or polls, such as for companies marketing research, for which results will be private.

The various processes described herein may be implemented or performed by a machine with a processor coupled to memory and running hardware or software applications. The machine may be selected from the group comprising a computer, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The processor may be selected from the group comprising a microprocessor, a controller, microcontroller, state machine, combinations of the same, or the like. The processor may also be implemented as a combination of computing devices, e.g., a combination of a DSP and a microprocessor, a plurality of microprocessors or processor cores, one or more graphics or stream processors, one or more microprocessors in conjunction with a DSP, or any other such configuration.

The processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, hard disk, a removable disk, a CD-ROM, memory capable of storing firmware, or any other form of computer-readable storage medium known in the art. An exemplary computer-readable storage medium can be coupled to a processor such that the processor can read information from, and write information to, the computer-readable storage medium. In the alternative, the computer-readable storage medium may be integral to the processor. The processor and the computer-readable storage medium may reside in an ASIC.

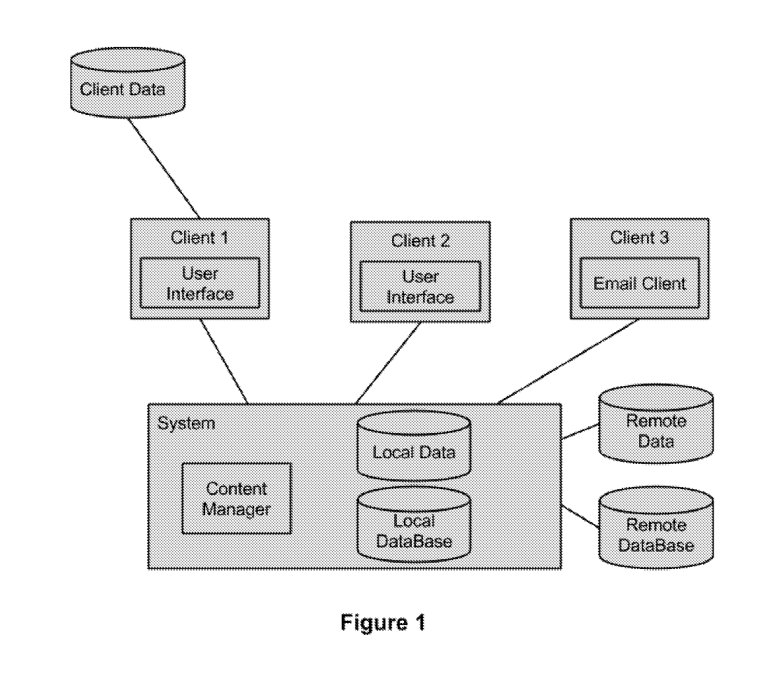

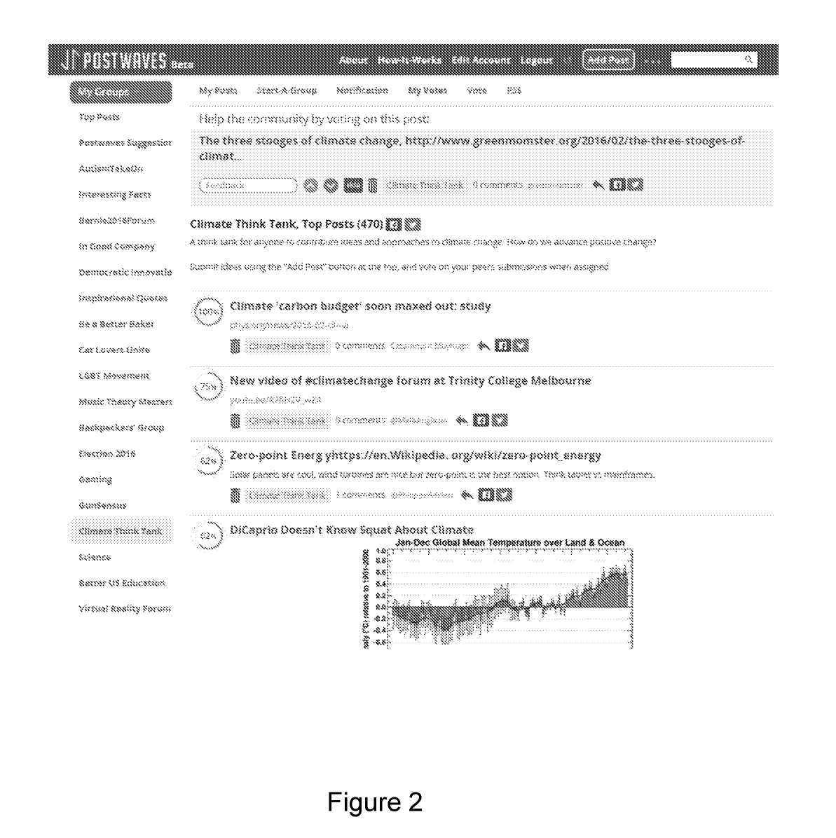

Turning to FIG. 1, which shows one possible implementation where the content manager is running on a system server, the content manager has local and remote data and database and is communicating with multiple clients applications that may be system specific client with a user interface, or use standard email communication. The content manager software is executing the method for ranking and evolving content described above and saves related state information in the local and remote data and databases. Turning to FIG. 2, a screen shot wherein a website is the user interface is shown. The user signs up using various methods, including but not limited to Twitter, Facebook, email or LinkedIn accounts. After sign up, the user logs in to view the left hand side of the website that lists “my groups”. The user selects a group in sidebar. In this example, the user has selected “Climate Think Tank.” The top posts are listed in order of preapproved content for the day, allowing the user to access preapproved and relevant content on the subject of Climate Think Tank. Additionally, the user is assigned to vote on content submissions, which is shown at the top of the page. In this case the content is an article titled “The three stooges of climate change.” The user provides feedback, votes up, votes down or skips the content if not relevant to user. The “My votes” tab shows user all content user is assigned to vote on or provide feedback. Additionally, a user may submit a post to a group by clicking on the “add post” button. A user may reply to content and send that to a group anonymously for feedback, upvote or downvote by clicking on the left pointing arrow next to the content. A user may check the status of their submissions and view feedback or voting results, even if the content does not pass the screening process to be viewed by the entire group.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A computer-implemented method for reducing user biases and clutter when ranking user content, the method comprising the steps of:
a. selecting users from at least one online grouping of users;
b. calculating a first small subset of the users in the online grouping of users;
c. anonymously submitting content to the first subset of users wherein the first subset of users review and anonymously respond to the content;
d. increasing the weight of content with a positive response from the first subset of users by a calculated value;
e. decreasing the weight of content with a negative response from the first subset of users by a calculated value;
f. repeating steps b-e for a predetermined period of time, number of iterations or until a predetermined end point is reached; and
g. assigning a numerical value of the content based on responses from the subsets of users and comparing it to a predetermined numerical threshold wherein only if the numerical weight of the content is higher than a calculated numerical threshold, the content is made available to all users from the online grouping of users.

2. The computer-implemented method of claim 1 wherein the content submitter is no longer anonymous once the content is made available to all users.

3. The computer-implemented method of claim 1 further comprising removing content if the numerical weight of the content is lower than a predetermined numerical threshold.

4. The computer-implemented method of claim 1 further comprising using calculations to suggest new user groupings based on user interest in content submissions.

5. The computer-implemented method of claim 1 wherein the content submission may include at least one action requested from the users receiving the content.

6. The computer-implemented method of claim 1 wherein the content and rating results are made available only to the submitter.

7. The computer-implemented method of claim 1 wherein the user interface is selected from the group comprising electronic mail, website, mobile application interface (API) or combinations thereof.

8. The computer-implemented method of claim 1 wherein a member of the online grouping of users submits the content.

9. The computer-implemented method of claim 8 further comprising limiting the amount of content that can be submitted by any one user of the online grouping of users.

10. The computer-implemented method of claim 9 wherein the limitation on the user is a function of the amount of previously submitted content being made available to all users.

11. The computer-implemented method of claim 1 wherein the content submitted is created by a source outside of the online grouping of users.

12. The computer-implemented method of claim 11 wherein the content source is selected from the group comprising a social media network, a social messaging service, a social content sharing service, an e-mail message service, an instant message service, a short message service (SMS) message, a web service, a weblog, a search engine or combinations thereof.

13. The computer-implemented method of claim 1 wherein the content is automatically submitted from a source wherein an online grouping of users may find value in ranking content.

14. The computer-implemented method of claim 13 wherein the source is selected from the group comprising really simple syndication (RSS) feed, an atom feed, an extensible markup language (XML) feed, or a JavaScript Object Notation (JSON) format.

15. The computer-implemented method of claim 1 further comprising allowing the users to limit the number of submissions received.

16. A computer-implemented system for reducing user biases when ranking user content is disclosed, the system generally comprising:
a. a machine;
b. a processor;
c. a memory coupled to the processor; and
d. software or hardware which when executed by a the processor cause the processor to perform the method for reducing user biases when ranking user content, the method comprising:
i. selecting users from at least one online grouping of users;
ii. calculating a first small subset of the users in the online grouping of users;
iii. anonymously submitting content to the first subset of users wherein the first subset of users review and anonymously respond to the content;
iv. increasing the weight of content with a positive response from the first subset of users by a calculated value;
v. decreasing the weight of content with a negative response from the first subset of users by a calculated value;
vi. repeating steps b-e for a predetermined period of time, number of iterations or until a predetermined end point is reached; and
vii. assigning a numerical value of the content based on responses from the subsets of users and comparing it to a predetermined numerical threshold wherein only if the numerical weight of the content is higher than the predetermined numerical threshold, the content is made available to all users from the online grouping of users.

16. The computer-implemented system of claim 15 wherein the method is fully automated by software modules residing in a computer-readable storage medium executed by one or more machines.

17. The computer-implemented system of claim 16 wherein the computer-readable storage medium is selected from the group comprising RAM memory, flash memory, ROM memory, EPROM memory, EEPROM memory, registers, hard disk, a removable disk, a CD-ROM, memory capable of storing firmware or combinations thereof.

18. The computer-implemented system of claim 17 wherein the machine is selected from the group comprising a computer, a digital signal processor (DSP), an application specific integrated circuit (ASIC), a field programmable gate array (FPGA) or other programmable logic device, discrete gate or transistor logic, discrete hardware components, or any combination thereof.

19. The computer-implemented system of claim 15 wherein the processor is selected from the group comprising a microprocessor, a controller, microcontroller, state machine, a combination of computing devices, a plurality of microprocessors or processor cores, one or more graphics or stream processors, one or more microprocessors in conjunction with a DSP or any combination thereof.

20. A non-transient computer-readable medium storing instructions, which when executed by a processor cause the processor to perform a method for reducing user biases when ranking user content, the method comprising:
a. selecting users from at least one online grouping of users;
b. calculating a first small subset of the users in the online grouping of users;
c. anonymously submitting content to the first subset of users wherein the first subset of users review and anonymously respond to the content;
d. increasing the weight of content with a positive response from the first subset of users by a calculated value;
e. decreasing the weight of content with a negative response from the first subset of users by a calculated value;
f. repeating steps b-e for a predetermined period of time, number of iterations or until a predetermined end point is reached; and
g. assigning a numerical value of the content based on responses from the subsets of users and comparing it to a predetermined numerical threshold wherein only if the numerical weight of the content is higher than the predetermined numerical threshold, the content is made available to all users from the online grouping of users.
